(19) United States
(12) Patent Application Publication
(10) Pub. No.: US 2024/0149236 A1
(43) Pub. Date: May 9, 2024

(54) THERMALLY EXPANDABLE CELLULOSE-BASED MICROSPHERES

(71) Applicant: NOURYON CHEMICALS INTERNATIONAL B.V., Amsterdam (NL)

(72) Inventors: Bo ANDREASSON, Sundsvall (SE); Roel WIJTMANS, Sundsvall (SE); Elwin SCHOMAKER, Arnhem (NL); Helena BERGENUDD, Arnhem (NL)

(73) Assignee: NOURYON CHEMICALS INTERNATIONAL B.V., Amsterdam (NL)

(21) Appl. No.: 18/547,388

(22) PCT Filed: Nov. 19, 2021
(86) PCT No.: PCT/EP2021/082363

§ 371 Date: Aug. 22, 2023

(30) Foreign Application Priority Data
Feb. 22, 2021 (EP) 21158552.6

(51) Int. Cl. B01J 13/04

(52) U.S. Cl. CPC B01J 13/043

(57) ABSTRACT

Thermally expandable microspheres include a polymeric shell surrounding a hollow core, wherein the hollow core comprises a blowing agent, and the polymeric shell comprises an acetate-functionalised cellulose having a glass transition temperature of from about 150 to about 250° C. and a hydrogen bond donor chosen from alcohols, urea, and carboxylic acids. The microspheres are formed using a process including the step of mixing an acetate-functionalised cellulose, an organic solvent, a blowing agent and a hydrogen bond donor to form a mixture and then spraying the mixture into drying equipment to produce the thermally expandable microspheres.

### CROSS-REFERENCE TO RELATED APPLICATION

This application is a U.S. National-Stage entry under 35 U.S.C. § 371 based on International Application No. PCT/EP2021/082363, filed Nov. 19, 2021, which was published under PCT Article 21(2) and which claims priority to European Application No. 21158552.6, filed Feb. 22, 2021, which are all hereby incorporated in their entirety by reference.

### TECHNICAL FIELD

The present disclosure relates to thermally expandable microspheres made from cellulose-based biopolymers, and also to a process for their production.

### BACKGROUND

Thermally expandable microspheres are known in the art, and are described for example in U.S. Pat. No. 3,615,972, WO 00/37547 and WO2007/091960. A number of examples are sold under the trade name Expancel®. They can be expanded to form extremely low weight and low density fillers, and find use in applications such as foamed or low density resins, paints and coatings, cements, inks and crack fillers. Consumer products that often contain expandable microspheres include lightweight shoe soles (for example for running shoes), textured coverings such as wallpaper, solar reflective and insulating coatings, food packaging sealants, wine corks, artificial leather, foams for protective helmet liners, and automotive weather strips.

Thermally expandable polymer microspheres usually comprise a thermoplastic polymeric shell, with a hollow core comprising a blowing agent which expands on heating. Examples of blowing agents include low boiling hydrocarbons or halogenated hydrocarbons, which are liquid at room temperature, but which vapourise on heating. To produce expanded microspheres, the expandable microspheres are heated, such that the thermoplastic polymeric shell softens, and the blowing agent vapourises and expands, thus expanding the microsphere. Typically, the microsphere diameter can increase between 1.5 and 8 times during expansion.

Expandable microspheres are marketed in various forms, e.g. as dry free-flowing particles, as aqueous slurry or as a partially dewatered wet cake.

Expandable microspheres can be produced by polymerizing ethylenically unsaturated monomers in the presence of a blowing agent, for example using a suspension-polymerisation process. Typical monomers include those based on acrylates, acrylonitriles, acrylamides, vinylidene dichloride and styrenes. A problem associated with such thermoplastic polymers is that they are typically derived from petrochemicals, and are not derived from sustainable sources. In addition, many polymers are non-biodegradable, or at least biodegrade so slowly that they risk cumulative build-up in the environment. However, it is not necessarily easy merely to replace the monomers with more sustainable-derived alternatives, since it is necessary to ensure that acceptable expansion performance is maintained. For example, the polymer must have the right surface energy to get a core-shell particle in a suspension polymerization reaction so that the blowing agent is encapsulated. In addition, the produced polymer must have good gas barrier properties to be able to retain the blowing agent. Further, the polymer must have suitable viscoelastic properties above glass transition temperature T_{g} so that the shell can be stretched out during expansion. Therefore, replacement of conventional monomers by bio-based monomers is not easy.

Expandable microspheres have been described, in which at least a portion of the monomers making up the thermoplastic shell are bio-based, being derivable from renewable sources.

WO2019/043235 describes polymers comprising lactone monomers with general formula:

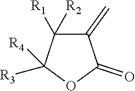

where R₁-R₄ are each independently selected from H and C₁₋₄ alkyl.

WO2019/101749 describes copolymers comprising itaconate dialkylester monomers of general formula:

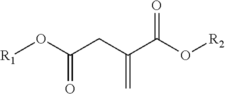

where each of R₁ and R₂ are separately selected from alkyl groups.

Published patent application WO 2020/099440 (PCT/EP2019/081076) discloses thermally expandable microspheres made from cellulose-based biopolymers. The polymeric shell of these microspheres comprises a carboxylate-functionalised cellulose having a glass transition temperature (T_{g}) of at least 125° C. In WO 2020/099440 the microspheres are prepared by solvent evaporation or solvent extraction. However, these techniques have some drawbacks such as limited scale-up possibilities and, hence, limited capacity, the necessity of additional product drying steps and handling of large amounts of contaminated water. It would be desirable if the microspheres could be produced by a method not having these drawbacks.

Hence, there remains a need for alternative thermoplastic expandable microspheres in which the thermoplastic polymer shell is, at least in part, derived from sustainable sources. Moreover, there further remains a need for providing expandable microspheres in which the thermoplastic polymer shell is, at least in part, derived from sustainable sources and wherein the expandable microspheres have desirable expansion characteristics such as for instance a desirably low density of the expanded microspheres. Moreover, it would be desirable if such expandable microspheres derived from sustainable sources have sufficient or even improved storage stability. Furthermore, it would be desirable if these microspheres could be produced by a method which allows for efficient production scale-up of, and which does not require additional product drying steps and handling of large amounts of contaminated water. In addition, other objects, desirable features and characteristics will become apparent from the subsequent summary and detailed description, and the appended claims, taken in conjunction with the accompanying drawings and this background.

### BRIEF SUMMARY

The present disclosure relates to thermally expandable microspheres comprising a polymeric shell surrounding a hollow core, wherein the hollow core comprises a blowing agent, and the polymeric shell comprises an acetate-functionalised cellulose having a glass transition temperature (T_{g}) within the range of from about 150 to about 250° C. and a hydrogen bond donor chosen from alcohols, urea, and carboxylic acids, preferably a hydrogen bond donor in the form of a carboxylic acid.

The present disclosure is also directed to a process for preparing expandable microspheres as well as to thermally expandable microspheres obtained by such process, the process comprising mixing an acetate-functionalised cellulose having a glass transition temperature (T_{g}) within the range of from 150 to 250° C., an organic solvent, a blowing agent and a hydrogen bond donor chosen from alcohols, urea, and carboxylic acids, preferably a hydrogen bond donor in the form of a carboxylic acid, and then spraying the thus obtained mixture into a drying equipment to produce the thermally expandable microspheres having a polymeric shell surrounding a hollow core, in which the polymeric shell comprises the acetate-functionalised cellulose, and the hollow core comprises the blowing agent.

### BRIEF DESCRIPTION OF DRAWINGS

The present disclosure will hereinafter be described in conjunction with the following drawing figures, wherein like numerals denote like elements, and:

FIG. 1A illustrates a single core microsphere;

FIG. 1B illustrates a multi-core microsphere; and

FIG. 2 is a line graph of expansion as a function of temperature showing Tₛₜₐᵣₜ, Tₘₐₓ and Lₘₐₓ as determined by thermo-mechanical analysis (TMA).

### DETAILED DESCRIPTION

The following detailed description is merely exemplary in nature and is not intended to limit the present disclosure or the application and uses of the present disclosure. Furthermore, there is no intention to be bound by any theory presented in the preceding background of the present disclosure or the following detailed description. Moreover, it is contemplated that, in various non-limiting embodiments, it is to be appreciated that all numerical values as provided herein, save for the actual examples, are approximate values with endpoints or particular values intended to be read as “about” or “approximately” the value as recited.

The present disclosure is directed to finding thermally expandable polymeric microspheres having desirable expansion characteristics such as for instance a desirably low density of the expanded microspheres by using bio-derived polymers and which, at the same time, preferably have sufficient or even improved storage stability. It has further been found that these microspheres can be efficiently produced using spray drying methods which can be easily and efficiently scaled up and which do not require additional product drying steps and handling of large amounts of contaminated water.

The present disclosure discloses thermally expandable microspheres comprising a polymeric shell surrounding a hollow core, wherein the hollow core comprises a blowing agent, and the polymeric shell comprises an acetate-functionalised cellulose having a glass transition temperature (T_{g}) within the range of from 150 to 250° C. and a hydrogen bond donor chosen from alcohols, urea, and carboxylic acids, preferably a hydrogen bond donor in the form of a carboxylic acid, such as a dicarboxylic acid, a tricarboxylic acid or a tetracarboxylic acid.

The expandable microspheres are based on a polymeric shell comprising an acetate-functionalised cellulose. The functional group is an acetate group, or more than one acetate group. Thus, the term “acetate-functionalised cellulose” means that the cellulose comprises at least one acetate group. The acetate moiety forms part of the link between the acetate functional group and the cellulose, i.e. the cellulose is linked to the acetate functional group via an ester link.

The polymeric shell can comprise or consist of one or more polymeric components, in which at least one component, more than one component or all polymeric components are selected from such acetate-functionalised celluloses. Where there the shell comprises polymers other than those described herein (i.e. acetate-functionalised cellulose), their content is typically less than 50 wt %, for example less than 30 wt %, or less than 10 wt %, such as 9 wt % or below, 5 wt % or below or even 2 wt % or below. These percentages are based on the total polymer content of the shell.

In a particular embodiment, the polymeric shell comprises only one polymeric component being an acetate-functionalised cellulose, more particularly cellulose acetate, having a glass transition temperature, T_{g}, within the range of from 150° C. to 250° C.

The acetate-functionalised cellulose may comprise one or more further carboxylate functionalities which are different from acetate. If the acetate-functionalised cellulose comprises more than one further carboxylate functionalities which are different from acetate these further carboxylate functionalities are different from each other. For instance, in embodiments, the acetate-functionalised cellulose may comprise one further carboxylate functionality which is different from acetate. However, it is preferred that the acetate-functionalised cellulose does not comprise a further carboxylate functionality which is different from acetate.

In embodiments, if the acetate-functionalised cellulose comprises a further carboxylate functionality which is different from acetate, the further carboxylate functional group on the acetate-functionalised cellulose can be represented by formula (1).

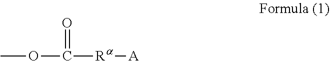

In Formula (1), A is selected from —H, —OH, —OR^{b}, —C(O)OH and —C(O)OR^{b}. In embodiments, A is selected from —H and —C(O)OH.

R^{a} can be absent, i.e. A can be directly attached to the C═O group. However, where present, R^{a} can be selected from saturated or unsaturated aliphatic groups having from 1 to 11 carbon atoms, and which can be linear, branched or cyclic.

R^{a} can also be selected from 5- and 6-membered aromatic rings.

R^{a} can optionally comprise one or more substituents selected from —OH, halide, C₁₋₄ alkyl, and C₁₋₄ alkoxy, where the C₁₋₄ alkyl and C₁₋₄ alkoxy groups are optionally substituted with one or more groups selected from halide and —OH.

R^{a} in embodiments comprises from 1 to 7 carbon atoms, for example from 1 to 5, or from 1 to 3 carbon atoms.

R^{b} on each occurrence is independently selected from a C₁₋₄ alkyl group, for example a C₁₋₂ alkyl group, optionally with one or more substituents selected from halide and —OH groups. In embodiments, the C₁₋₄ alkyl group or C₁₋₂ alkyl groups are unsubstituted.

In embodiments, R^{a} can be a saturated linear or branched aliphatic CᵥR₂ᵥ^{c} group or a cyclic C_{w}R_{2w-2}^{c} aliphatic group. v is an integer in the range of from 1 to 11, for example in the range of from 1 to 8, such as from 1 to 6 or from 1 to 4. w is an integer in the range of from 3 to 11, for example from 4 to 6.

R^{c} on each occurrence is independently selected from H, —OH, halide, C₁₋₄ alkyl, and C₁₋₄ alkoxy, where the C₁₋₄ alkyl and C₁₋₄ alkoxy groups are optionally substituted with one or more groups selected from halide and —OH.

In other embodiments, R^{a} can be an unsaturated linear or branched aliphatic CₓR_{2x-2y}^{c} group comprising “y” double bonds. x is an integer in the range of from 2 to 11, for example from 2 to 6 or from 2 to 4. y represents the number of double bonds, and is typically 1 or 2.

In further embodiments, R^{a} can be an unsaturated cyclic aliphatic C_{w}R_{2w-2y-2}^{c} group comprising “y” double bonds, where y is typically 1 or 2.

In still further embodiments, R^{a} can be a C_{z}R_{z-2}^{c} aromatic group. z is an integer selected from 5 and 6.

In still further embodiments, R^{a} can be a linear or branched aliphatic group comprising a cyclic aliphatic or aromatic ring. Thus, R^{a} can be a CₚR_{2p-2q}^{c}-E-CᵣR₂ᵣ₋₂ₛ^{c} group having no more than 11 carbon atoms, where E is C_{w}R_{2w-2}^{c}, C_{w}R_{2w-2y-2}^{c}, or C_{z}R_{z-2}^{c} as defined above. p and r are each independently a whole number from 0 to 8, where p+r is at least 1. q and s are each the number of double bonds in the respective non-cyclic aliphatic component. In embodiments, each of q and s are independently selected from 0, 1 and 2.

Halides are typically selected from F and Cl. In embodiments, however, the functional group is halide-free, such that there are no halides in groups A, R^{a}, R^{b} and R^{c}.

In embodiments, at least one R^{c} group is H. In other embodiments no more than two R^{c} groups are other than H, and in further embodiments, no more than one R^{c} group is other than H. In still further embodiments, all R^{c} groups are H.

In the above definitions of R^{a}, R^{b} and R^{c}, where there is more than one —OH substituent, there is typically no more than one —OH substituent per carbon atom.

In certain embodiments, R^{a} is an optionally substituted C₁-C₈ aliphatic (alkylene) group. In other embodiments, R^{a} is an optionally substituted C₆ aromatic ring. In further embodiments, R^{a} is unsubstituted.

In embodiments, the further carboxylate functionality on the cellulose substituent is selected from propionate, butyrate, pentanoate, hexanoate, heptanoate, octanoate and phthalate. In further embodiments, it is selected from propionate and butyrate.

The degree of substitution (DS) of the hydroxyl groups of the cellulose by the acetate and, if present, the one or more further carboxylate functionalities can be in the range of from 0.9 to 4.0, preferably from 0.9 to 3.5, and in embodiments is in the range of from 1.5 to 3.5, for example in the range of from 2.0 to 3.0.

If the acetate-functionalized cellulose comprises one or more further carboxylate functionalities, the degree of substitution (DS) by the acetate is higher than the degree of substitution (DS) by the one or more further carboxylate functionalities. In other words, an acetate-functionalized cellulose according to the present disclosure contains more acetate groups (i.e. acetate functionalities) than groups (i.e. functionalities) of the one or more further carboxylate functionalities. In embodiments, it is preferred that the degree of substitution (DS) by the one or more further carboxylate functionalities is not more than 1.0, for example no more than 0.5 or no more than 0.2, or even no more than 0.1.

In embodiments, in the acetate-functionalized cellulose the degree of substitution (DS) by the acetate is in the range of from 0.9 to 3.5, for instance from 1.5 to 3.5 or from 2.0 to 3.0, and the degree of substitution (DS) by the one or more further carboxylate functionalities is not more than 1.0, for example no more than 0.5 or no more than 0.2, or even no more than 0.1, provided that the degree of substitution (DS) by the acetate is higher than the degree of substitution (DS) by the one or more further carboxylate functionalities.

In preferred embodiments, in the acetate-functionalized cellulose the degree of substitution (DS) by the acetate is in the range of from 2.0 to 3.0, and the degree of substitution (DS) by the one or more further carboxylate functionalities is not more than 1.0, for example no more than 0.5 or no more than 0.2, or even no more than 0.1.

The degree of substitution (DS) is a measure for the average number of hydroxyl groups per glucose unit of the cellulose which are substituted with other groups, such as carboxylic acid groups and in particular acetate groups. Hence, the degree of substitution (DS) of cellulose cannot be more than 4.0. The degree of substitution (DS) can be determined by the method AS TM D817-12.

Optionally, other functional groups which are not carboxylate-functional groups may be present in the acetate-functionalised cellulose. For example, —OH groups on the cellulose molecule that are not already substituted with a carboxylate-functionality can be replaced by an alkoxy group, or more than one alkoxy group, e.g. selected from C₁ to C₆ alkoxy groups. In other embodiments, although less preferred, the —OH group can be replaced with a halide group, for example F or Cl. Where such other functional groups are present, they are in lower molar quantities than the one or more carboxylate groups.

In embodiments, the degree of substitution of the cellulose by other functional groups (i.e functional groups which are not acetate or further carboxylate-functional groups) is no more than 1.0, for example no more than 0.5 or no more than 0.2. In further embodiments, the degree of substitution by groups other than carboxylate groups is no more than 0.1. However, the degree of substitution of the cellulose by other functional groups is lower than the degree of substitution by the acetate.

In particular embodiments, the acetate-functionalized cellulose is cellulose acetate having a degree of substitution (DS) by acetate in the range of from 0.9 to 4.0, such as from 0.9 to 3.5, particularly from 1.5 to 3.5, more particularly from 2.0 to 3.0. As used herein, reference to “cellulose acetate” means that no other functionalities other than acetate groups and hydroxyl groups are present in the cellulose.

The glass transition temperature (T_{g}) of the acetate-functionalised cellulose that forms the shell of the microspheres or at least part of the shell of the microspheres is within the range of from 150° C. to 250° C., such as from 150° C. to 190° C. In a preferred embodiment, the polymeric shell comprises an acetate-functionalised cellulose having a glass transition temperature within the range of from 150° C. to 190° C. The T_{g} can be measured using differential scanning calorimetry (DSC), for example using the method described by Nishio et al; Cellulose, 2006 (13), 245-259, in which 5 mg sample is heated for a first time at a rate of 20° C./min under a nitrogen atmosphere from ambient temperature (25° C.) to 240° C., and then immediately quenched to −50° C., before being heated for a second time from −50° C. to 240° C. at 20° C./min under a nitrogen atmosphere, the T_{g} calculation being based on the second heating cycle.

In further embodiments, the T_{g} of the acetate-functionalised cellulose is in the range of from 160 to 220° C., for example in the range from 160 to 200° C., from 160 to 190° C., from 170 to 185° C. or from 175 to 185° C.

The melting point of the acetate-functionalised cellulose is typically above the T_{g} value, and in embodiments is above 200° C. In embodiments, the melting point is above 220° C. The melting point is typically no more than 270° C., for example no more than 260° C. or no more than 250° C.

The T_{g} and the melting point of the acetate-functionalised cellulose can be modified or controlled by varying the functional groups on the acetate-functionalised cellulose or by varying the molecular weight or by varying the degree of substitution.

The thermally expandable microspheres are hollow, in which the shell comprises the acetate-functionalised cellulose, and the hollow center or core comprises one or more blowing agents. The acetate-functionalised celluloses used to prepare the microspheres typically have a density of 1.1-1.35 g/cm³. In the expanded microspheres, the density is typically less than 1 g/cm³, and is suitably in the range of from 0.005 to 0.8 g/cm³, or from 0.01 to 0.6 g/cm³. In further embodiments, the density of the expanded microspheres is in the range of from 0.01 to 0.4 g/cm³, such as for instance in the range from 0.01 to 0.2 g/cm³ and preferably in the range from 0.01 to 0.15 g/cm³. Higher densities, particularly densities of 1 g/cm³ or more, generally mean that the microsphere samples are not suitable for use.

In embodiments, the number average molecular weight (Mₙ) of the acetate-functionalised cellulose used to form the microspheres is in the range of from 1,000 to 700,000, for example in the range of from 2,000 to 500,000, from 2,000 to 100,000, from 2,000 to 80,000 or from 2,000 to 50,000 Da. In embodiments, it is in the range of from 5,000 to 50,000, for example from 10,000 to 50,000.

Examples of suitable acetate-functionalised celluloses are cellulose acetates having a number average molecular weight (Mₙ) in the range of from 1,000 to 700,000, for example in the range of from 2,000 to 500,000, from 2,000 to 100,000, from 2,000 to 80,000 or from 2,000 to 50,000 Da, preferably in the range of from 5,000 to 50,000, and more preferably in the range of from 10,000 to 50,000.

In particular embodiments, the acetate-functionalized cellulose is cellulose acetate having a degree of substitution (DS) by acetate in the range of from 0.9 to 4.0, such as from 0.9 to 3.5, particularly from 1.5 to 3.5, more particularly from 2.0 to 3.0, and having a number average molecular weight (Mₙ) in the range of from 1,000 to 700,000, for example in the range of from 2,000 to 500,000, from 2,000 to 100,000, from 2,000 to 80,000 or from 2,000 to 50,000 Da, preferably in the range of from 5,000 to 50,000, and more preferably in the range of from 10,000 to 50,000.

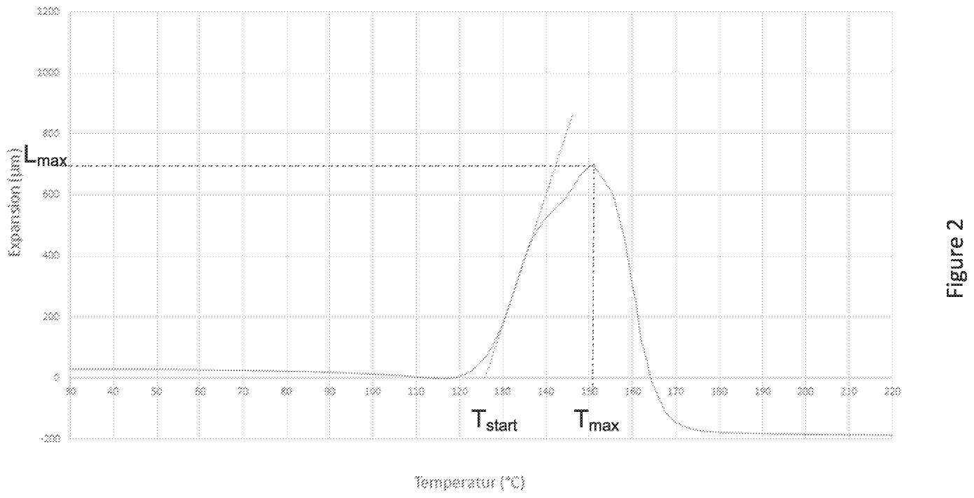

The thermally expandable microspheres may have a temperature at which expansion starts, T_{Start}, of above 140° C., such as from 150° C. to less than 250° C. The temperature at which expansion starts is called T_{Start}, while the temperature at which maximum expansion is reached is called Tₘₐₓ. T_{Start} and T_{Max} may be determined using standard measuring techniques as commonly known by the skilled person. For instance, T_{Start} and T_{Max} can be determined in a temperature ramping experiment, by using for example a Mettler-Toledo Thermomechanical Analyser, such as Mettler-Toledo TMA/SDTA 841e, by using a heating rate of 20° C./min and a load (net.) of 0.06 N. In such a temperature ramping experiment, a sample of known weight of the thermally expandable microspheres is heated with a constant heating rate of 20° C./min under a load (net.) of 0.06 N. When expansion of the thermally expandable microspheres starts, the volume of the sample increases and moves the load upwards. From such measurement, an expansion thermogram (an exemplary thermogram is shown in FIG. 2) is obtained wherein the ordinate indicates the height of moving the load upwards and the abscissa indicates the temperature. T_{Start} and T_{Max} can be determined from this expansion thermogram for instance by using STARe software from Mettler-Toledo.

In embodiments, the thermally expandable microspheres have a T_{Start} in the range of from 155° C. to 220° C., such as from 160° C. to less than 200° C. Preferably, the thermally expandable microspheres may have a T_{Start} in the range of from 160° C. to 190° C., preferably from 165° C. to 185° C. and more preferably from 165° C. to 180° C. Even more preferably the thermally expandable microspheres have a T_{Start} in the range from 165° C. to 175° C.

To further enhance the properties of the polymer shell, the polymeric shell of the thermally expandable microspheres comprises a hydrogen bond donor chosen from alcohols, urea, and carboxylic acids, preferably a hydrogen bond donor in the form of a carboxylic acid. The hydrogen bond donor may interact via hydrogen bonds with groups on the acetate-functionalised celluloses. By adding a hydrogen bond donor chosen from alcohols, urea, and carboxylic acids, preferably a hydrogen bond donor in the form of a carboxylic acid, it is possible to further improve the barrier properties of the polymer shell and to improve the mechanical properties of the polymer shell and thus the expansion properties of the microspheres. Thus, the hydrogen bond donor functions as a polymer shell enhancer. Moreover, the density after storage for instance for 4 weeks, can be improved.

The hydrogen bond donor may be a polymer having for instance an average molecular weight of up to 10000 g/mol, such as from 1000 g/mol up to 5000 g/mol or from 1500 g/mol up to 3000 g/mol. The hydrogen bond donor may also be, and the hydrogen bond donor typically and preferably is, a low-molecular weight compound having for instance a molecular weight of less than 2000 g/mol, preferably less than 1500 g/mol, more preferably less than 1000 g/mol and even more preferably less than 500 g/mol. For instance, the hydrogen bond donor may have a molecular weight in the range of 20 to 500 g/mol, preferably between 30 and 400 g/mol, and even more preferably between 40 and 300 g/mol.

Hydrogen bond donors chosen from alcohols, urea, and carboxylic acids are compounds having hydrogen atoms covalently bound to a more electronegative atom, i.e. oxygen (if the hydrogen bond donor is an alcohol or a carboxylic acid) or nitrogen (if the hydrogen bond donor is urea) , where these hydrogen atoms form intermolecular hydrogen bonds with functional groups (hydrogen bond acceptors) of the acetate-functionalised cellulose, such as the acetate groups, the one or more further carboxylate functionalities, hydroxyl groups and ether groups, in particular the acetate groups and, if present, the one or more further carboxylate functionalities.

The hydrogen bond donor is chosen from alcohols, urea, and carboxylic acids. Preferably, the hydrogen bond donor is chosen from alcohols and carboxylic acids. In a more preferred embodiment, the hydrogen bond donor is a carboxylic acid. In another more preferred embodiment, the hydrogen bond donor is an alcohol.

The hydrogen-bond donor chosen from alcohols, urea, and carboxylic acids, preferably the hydrogen bond donor in the form of a carboxylic acid, may have a molecular weight in the range of 20 to 2000 g/mol and preferably has a molecular weight in the range of 20 to 500 g/mol, more preferably between 30 and 400 g/mol, and even more preferably between 40 and 300 g/mol.

If the hydrogen bond donor is an alcohol, it may be selected from any compound containing at least one alcohol group, such as one, two, three, four, five or six alcohol groups, preferably having a molecular weight in the range of from 20 to 2000 g/mol. If the hydrogen bond donor is an alcohol, it is preferably a diol, triol, tetraol, pentaol or hexaol.

Suitable diols are for instance selected from 1,2-ethanediol, 1,2-propanediol, 1,3-propanediol, 1,2-butanediol, 1,3-butanediol, 2,3-butanediol, 1,4-butanediol, 1,2-pentanediol, 1,3-pentanediol, 1,4-pentanediol, 1,5-pentanediol, 1,2-hexanediol, 1,3-hexanediol, 1,4-hexanediol, 1,5-hexanediol, 1,6-hexanediol, 1,2-cyclohexanediol, 1,3-cyclohexanediol, and 1,4-cyclohexanediol, and is preferably 1,3-butanediol.

Suitable triols are for instance glycerol, 1,2,3-butanetriol, 1,2,4-butanetriol, 1,1,1-tris(hydroxymethyl)propane, pentanetriols, and hexanetriols. A preferred triol is glycerol.

Suitable tetraols are for instance ascorbic acid (Vitamin C), erythritol, threitol or pentaerythritol. Preferred tetraols are ascorbic acid (Vitamin C) and pentaerythritol.

Suitable pentaols are xylitol, arabitol, ribitol, glucose, fructose, galactose, and mannose.

Suitable hexaols are for instance sorbitol, mannitol, and cyclohexanehexol. A preferred hexaol is sorbitol.

If the hydrogen bond donor is an alcohol, it is preferably selected from 1,3-butanediol, glycerol, ascorbic acid (Vitamin C) or sorbitol.

The hydrogen bond donor is particularly preferably a carboxylic acid, i.e. a compound containing at least one carboxylic acid group, such as a monocarboxylic acid, a dicarboxylic acid, a tricarboxylic acid, a tetracarboxylic acid or a polycarboxylic acid, such as a polycarboxylic acid polymer. More particularly, the hydrogen bond donor is a carboxylic acid having a molecular weight in the range of from 20 to 2000 g/mol. Preferably the hydrogen bond donor is a carboxylic acid containing at least two carboxylic acid groups (—COOH), particularly a dicarboxylic acid, a tricarboxylic acid or a tetracarboxylic acid.

Examples of monocarboxylic acids are formic acid, acetic acid, propionic acid, butyric acid, valeric acid, caproic acid, benzoic acid, and lactic acid.

Examples of dicarboxylic acids are adipic acid, maleic acid, succinic acid, tartaric acid and aldaric acid.

Examples of tricarboxylic acids are citric acid and isocitric acid.

Examples of tetracarboxylic acids are pyromellitic acid (1,2,4,5-benzenetetracarboxylic acid), ethylenediaminetetraacetic acid (EDTA) and butanetetracarboxylic acids, such as 1,2,3,4-butanetetracarboxylic acid (BTCA).

Preferred examples of suitable hydrogen bond donors in the form of an carboxylic acid are citric acid, maleic acid, succinic acid, pyromellitic acid (1,2,4,5-benzenetetracarboxylic acid), lactic acid, tartaric acid, ethylenediaminetetraacetic acid (EDTA), butanetetracarboxylic acids, such as 1,2,3,4-butanetetracarboxylic acid (BTCA). Even more preferred examples of suitable hydrogen bond donors in the form of a carboxylic acid are pyromellitic acid (1,2,4,5-benzenetetracarboxylic acid), citric acid, tartaric acid, 1,2,3,4-butanetetracarboxylic acid (BTCA), and maleic acid.

Particularly, if the hydrogen bond donor is according to a preferred embodiment in the form of a carboxylic acid, it is chosen from pyromellitic acid (1,2,4,5-benzenetetracarboxylic acid), citric acid, tartaric acid, 1,2,3,4-butanetetracarboxylic acid (BTCA), and maleic acid.

More particularly, if the hydrogen bond donor is according to a preferred embodiment in the form of a carboxylic acid, it is chosen from pyromellitic acid (1,2,4,5-benzenetetracarboxylic acid), citric acid, tartaric acid, and 1,2,3,4-butanetetracarboxylic acid (BTCA).

Preferably, if the hydrogen bond donor is according to a preferred embodiment in the form of a carboxylic acid, it is a tricarboxylic acid or a tetracarboxylic acid, such as citric acid, pyromellitic acid (1,2,4,5-benzenetetracarboxylic acid) or 1,2,3,4-butanetetracarboxylic acid (BTCA).

In specific embodiments, if the hydrogen bond donor is according to a preferred embodiment in the form of a carboxylic acid, it is a tetracarboxylic acid, such as pyromellitic acid (1,2,4,5-benzenetetracarboxylic) acid or 1,2,3,4-butanetetracarboxylic acid (BTCA). Most preferred, the hydrogen bond donor is in the form of a carboxylic acid and is 1,2,3,4-butanetetracarboxylic acid (BTCA).

The amount of the hydrogen bond donor chosen from alcohols, urea, and carboxylic acids, preferably the hydrogen bond donor in the form of a carboxylic acid, used for preparing the expandable microspheres of the present disclosure is not particularly limited.

However, the amount of the hydrogen bond donor chosen from alcohols, urea, and carboxylic acids, preferably the hydrogen bond donor in the form of a carboxylic acid, may be from 0.01 to 50 wt % based on the total weight of the hydrogen bond donor and the acetate-functionalised cellulose. In embodiments, it can be in the range of from 0.01 to 40 wt %, for example in the range of from 0.05 to 30 wt %, in the range of from 0.1 to 20 wt % or even in the range of from 0.5 to 15 wt %, such as in the range of from 0.5 to 10 wt %, from 1.0 wt % to 5.0 wt %, or even from 1.2 wt % to 5 wt % or from 1.5 wt % to 5 wt %, the wt % being based on the total weight of the hydrogen bond donor and the acetate-functionalised cellulose.

In further embodiments, the polymeric shell can comprise particles to improve the mechanical properties and gas barrier of the polymer shell, thus also acting as polymer shell enhancers. Examples of such particles are talc, montmorillonite, nanocrystalline cellulose and various types of clay, such as bentonite.

A number of factors can result in high densities. For example, high density can result from poor microsphere yield, i.e. the percentage of microspheres in the polymeric material is too low to reduce the overall density to an acceptable level. Another issue is poor expansion characteristics, which can arise where too many of the microspheres contain insufficient blowing agent to enable adequate expansion. This can result from the polymer shell being too permeable to the blowing agent, or due to the formation of so-called “multiple core” microspheres where, instead of a single blowing agent-containing core, there are multiple blowing agent-containing cores within the shell (e.g. like a microspherical foam or sponge). In such multi-core microspheres, the blowing agent concentration is typically too low to reduce the density adequately. Another cause is aggregation or agglomeration of the polymer, resulting in poor microsphere production and a denser material. Too high a proportion of aggregated material or poorly expanding microspheres can also lead to large inhomogeneity in the expansion characteristics of the resulting microsphere product. This is particularly unfavourable for surface-sensitive applications such as coatings, where a smooth finish is desirable.

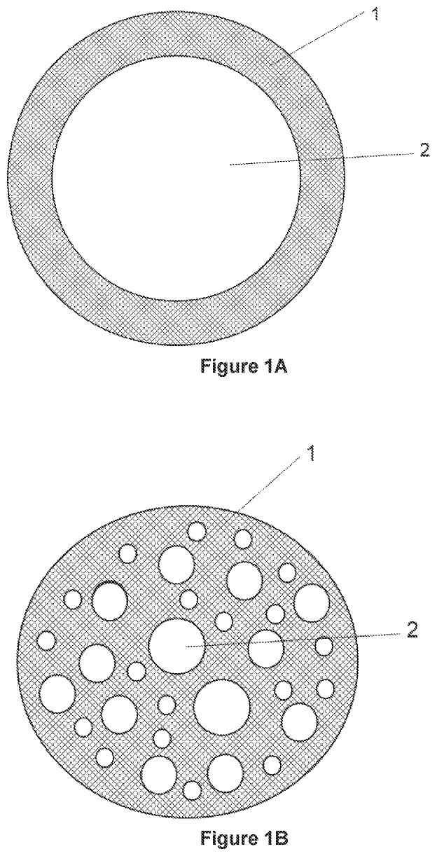

Illustrative cross sections of single core and multi-core microspheres are provided in FIGS. 1A and 1B respectively, where regions of polymer, 1, are represented by the cross-hatched areas, and blowing agent-containing regions, 2, are represented by blank areas.

The one or more blowing agents generally have a boiling point above 25° C. at 5.0 bara pressure or above 25° C. at 3.0 bara pressure, where “bara” stands for bar-absolute. In embodiments, they have a boiling point above 25° C. at atmospheric pressure (1.013 bara). Typically, they have a boiling point of 250° C. or less at atmospheric pressure, for example 220° C. or less, or 200° C. or less. They are preferably inert, and do not react with the functionalised cellulose shell. Boiling points at elevated pressures can be calculated using the Clausius Clapeyron equation.

Examples of blowing agents include dialkyl ethers, alkanes and halocarbons, e.g. chlorocarbons, fluorocarbons or chlorofluorocarbons. In embodiments, the dialkyl ether comprises two alkyl groups each selected from C₂ to C₅ alkyl groups. In embodiments, the alkane is a C₄ to C₁₂ alkane. In embodiments, the haloalkane is selected from C₂ to C₁₀ haloalkanes. The haloalkanes can comprise one or more halogen atoms selected from chlorine and fluorine. The alkyl or haloalkyl groups in the dialkyl ethers, alkanes and haloalkanes can be linear, branched or cyclic. One or a mixture of one or more blowing agents can be used.

In embodiments, for environmental reasons, the one or more blowing agents are selected from alkyl ethers and alkanes, and in further embodiments the one or more blowing agents are selected from alkanes. Haloalkanes are preferably avoided, due to their potential ozone depletion properties, and also due to their generally higher global warming potential.

Examples of suitable blowing agents that can be used include n-pentane, isopentane, neopentane, cyclopentane, cyclohexane, n-butane, isobutane, isohexane, neohexane, heptane, isoheptane, octane, isooctane, isodecane, and isododecane. In preferred embodiments, the blowing agent is selected from C₄ to C₁₂ iso-alkanes.

In the expandable microspheres, the one or more blowing agents are typically present in an amount of from 5 to 50 wt %, based on the total weight of functionalised cellulose and blowing agent(s), for example in the range of from 5 to 45 wt %, or from 10 to 40 wt %.

Acetate-functionalised cellulose materials can be purchased commercially, or can be made by known techniques, for example through mixing cellulose with a suitable carboxylic acid (i.e. acetic acid and, optionally, additional carboxylic acids) in the presence of a strong acid such as sulfuric acid, or by base-catalysed reaction of cellulose with acyl chloride, for example as described in Nishio et al; Cellulose, 2006 (13), 245-259.

Examples of suitable acetate-functionalised celluloses are cellulose acetate (CA) (i.e. acetate-functionalized cellulose which does not comprise a further carboxylate functionality different from acetate), cellulose acetate propionate (CAP) and cellulose acetate butyrate (CAB), particularly cellulose acetate (CA), cellulose acetate propionate (CAP) and cellulose acetate butyrate (CAB) having a number average molecular weight (Mₙ) in the range of from 2,000 to 100,000 Da, such as in the range of 2,000 to 80,000 Da, in the range of 10,000 to 50,000 Da or in the range of 20,000 to 50,000 Da.

Preferred acetate-functionalised celluloses are cellulose acetates (CA) (i.e. acetate-functionalized cellulose which does not comprise a further carboxylate functionality different from acetate) having a number average molecular weight (Mₙ) in the range of from 10,000 to 100,000 Da, such as within the range of 10,000 to 80,000 Da, preferably in the range of from 10,000 to 50,000 Da, and more preferably in the range of from 20,000 to 50,000 Da.

For instance, if the polymeric shell comprises cellulose acetate propionate (CAP) or cellulose acetate butyrate (CAB), the amount of the hydrogen bond donor in the form of a carboxylic acid which is used may be from 0.01 to 50 wt % based on the total weight of the hydrogen bond donor and the acetate-functionalised cellulose. In embodiments, it can be in the range of from 0.01 to 40 wt %, for example in the range of from 0.05 to 30 wt %, in the range of from 0.1 to 20 wt % or even in the range of from 0.5 to 15 wt %, such as in the range of from 0.5 to 10 wt % or in the range of from 1.0 to 5.0 wt %, the wt % being based on the total weight of the hydrogen bond donor and the acetate-functionalised cellulose.

For instance, if the polymeric shell comprises cellulose acetate (CA) (i.e. acetate-functionalized cellulose which does not comprise a further carboxylate functionality different from acetate), the amount of the hydrogen bond donor in the form of a carboxylic acid which is used may be from 0.01 to 50 wt % based on the total weight of the hydrogen bond donor and the acetate-functionalised cellulose. In embodiments, it can be in the range of from 0.01 to 40 wt %, for example in the range of from 0.05 to 30 wt %, in the range of from 0.1 to 20 wt % or even in the range of from 0.5 to 15 wt %, such as in the range of from 0.5 to 10 wt % or in the range of from 1.0 to 5.0 wt %, the wt % being based on the total weight of the hydrogen bond donor and the acetate-functionalised cellulose.

The expandable microspheres of the present disclosure are obtainable by a spray drying process comprising mixing the acetate-functionalised cellulose, an organic solvent, the blowing agent and the hydrogen bond donor chosen from alcohols, urea, and carboxylic acids, preferably the hydrogen bond donor in the form of an carboxylic acid, and then spraying the thus obtained mixture into a drying equipment to produce the thermally expandable microspheres having a polymeric shell surrounding a hollow core, in which the polymeric shell comprises the acetate-functionalised cellulose, and the hollow core comprises the blowing agent.

In principle, the spray drying equipment for performing the spray drying process is not limited and any conventional and commercially available spray drying equipment can be used for the spray drying process. A typical spray drying equipment suitable for the process described herein comprises a drying chamber equipped with a nozzle, an inlet for drying gas and an outlet which connects the drying chamber with a cyclone. Through the nozzle which is normally located at the top of the spraying chamber (but may be also located on any other portion of the spray dryer) the liquid to be atomized is sprayed, usually in combination with a spray gas, into the drying chamber. In the drying chamber, the atomized liquid is dried by the drying gas which is fed into the spraying chamber through the inlet for drying gas. The inlet of drying gas may for instance be located besides the nozzle. The atomized liquid dries and forms particles. The thus obtained particles are then fed together with the drying gas through the outlet of the drying chamber which is normally located in the bottom area of the drying chamber into a cyclone. In the cyclone the particles are separated from the drying air. The drying air may be further filtered to remove any residual particles from the drying air.

A suitable spray drying equipment for performing the spray drying process is the Büchi mini spray dryer B-290 which is commercially available from Büchi/Switzerland.

The order of adding the acetate-functionalised cellulose, the organic solvent, the blowing agent and the hydrogen bond donor chosen from alcohols, urea, and carboxylic acids, preferably the hydrogen bond donor in the form of a carboxylic acid, for mixing is not restricted and any order can be chosen.

However, in a preferred embodiment, in the process for producing the expandable microspheres, the acetate-functionalised cellulose is mixed first with the organic solvent, and then, in a further step the blowing agent and the hydrogen bond donor chosen from alcohols, urea, and carboxylic acids, preferably the hydrogen bond donor in the form of a carboxylic acid, is added to the mixture.

The mixing of the acetate-functionalised cellulose can be carried out at ambient temperature, although temperatures in the range of from 5 to 75° C. can be used. Mixing is usually performed till the acetate-functionalised cellulose has completely dissolved in the organic solvent.

In embodiments, the mixture of the acetate-functionalised cellulose with the organic solvent can be left or stirred for a period of time, for example from 1 to 100 hours, or from 2 to 50 hours. This can be at temperatures in the range of from 10 to 95° C., for example at a temperature of from 20 to 90° C.

In a further step, the blowing agent and the hydrogen bond donor chosen from alcohols, urea, and carboxylic acids, preferably the hydrogen bond donor in the form of a carboxylic acid, are added to the mixture of acetate-functionalised cellulose and organic solvent. The order of adding the blowing agent and the hydrogen bond donor chosen from alcohols, urea, and carboxylic acids, preferably the hydrogen bond donor in the form of a carboxylic acid, is not critical and, thus, the blowing agent may be added first, followed by the addition of the hydrogen bond donor chosen from alcohols, urea, and carboxylic acids, preferably the hydrogen bond donor in the form of a carboxylic acid, or, alternatively, the hydrogen bond donor chosen from alcohols, urea, and carboxylic acids, preferably the hydrogen bond donor in the form of a carboxylic acid, may be added first, followed by the addition of the blowing agent. Also this mixing step can be carried out at ambient temperature, although temperatures in the range of from 5 to 75° C. can be used. Also this mixing step is usually performed till the blowing agent and the hydrogen bond donor chosen from alcohols, urea, and carboxylic acids, preferably the hydrogen bond donor in the form of a carboxylic acid, have completely dissolved in the organic solvent.

After the addition of the blowing agent and the hydrogen bond donor chosen from alcohols, urea, and carboxylic acids, preferably the hydrogen bond donor in the form of a carboxylic acid, to the mixture of acetate-functionalised cellulose and organic solvent, the thus obtained mixture may be further stirred for a period of time, for example from 1 to 100 hours, or from 2 to 50 hours. Also this can be at temperatures in the range of from 10 to 95° C., for example at a temperature of from 20 to 90° C.

The mixture comprising the acetate-functionalised cellulose, the organic solvent, the blowing agent and the hydrogen bond donor chosen from alcohols, urea, and carboxylic acids, preferably the hydrogen bond donor in the form of a carboxylic acid, is then sprayed into a drying equipment to produce the thermally expandable microspheres as described herein. The drying equipment may be a spray drying equipment as described above.

The optional spray gas that is sprayed through the nozzle together with the liquid to be atomized is not particularly limited and may be any suitable spray gas known by the skilled person. For instance, the spray gas may be selected from nitrogen, carbon dioxide, (pressurized) air, noble gases, such as argon, etc. Preferably, in the method for producing expandable microspheres as described herein a spray gas is used and more preferably this spray gas is nitrogen.

Also the drying gas is not particularly limited and may be any suitable drying gas known by the skilled person. For instance, also the spray gas may be selected from nitrogen, carbon dioxide, (pressurized) air, noble gases, such as argon, etc. Preferably, the drying gas is nitrogen.

Further process parameters for running the spray drying equipment, such as the spray gas flow, the inlet temperature of the drying gas when entering the drying chamber, the feed rate of the liquid to be atomized and the aspirator speed to circulate the drying gas in the spray drying equipment can be readily chosen by the skilled person.

It has been found that with the above-described method it is possible to obtain expandable microspheres comprising a polymeric shell surrounding a hollow core, wherein the hollow core comprises a blowing agent, and the polymeric shell comprises an acetate-functionalised cellulose, wherein the thermally expandable microspheres have a temperature at which expansion starts, T_{Start}, of more than 140° C., such as from 150° C. to 250° C. It has been further found that this method is particularly suitable to obtain such expandable microspheres, wherein the polymeric shell further comprises a hydrogen bond donor chosen from alcohols, urea, and carboxylic acids, preferably a hydrogen bond donor in the form of a carboxylic acid.

The organic solvent can be selected from those having one or more functional group selected from esters, amides, aldehydes, ketones, alcohols (including glycols) and ethers, for example those having 3 to 12 carbon atoms. Esters, ketones and ethers may, in embodiments, be part of a cyclic structure. Further examples include haloalkanes having from 1 to 6 carbon atoms and halo-carboxylic acids having from 1 to 6 carbon atoms, where the halogen is selected from fluorine, chlorine, bromine and iodine.

Examples of organic solvents that can be used include ethyl acetate, ethyl formate, methyl acetate, n-propyl formate, iso-propyl formate, n-propyl acetate, iso-propyl acetate, iso-butyl acetate, n-butyl acetate, n-pentyl formate, iso-pentyl formate, n-pentyl acetate, iso-pentyl acetate, ethyl propionate, iso-butyl iso-butyrate, n-butyl propionate, ethyl 3-ethoxypropionate, 2-ethylhexyl acetate, acetone, methyl ethyl ketone, diethyl ketone, methyl isobutyl ketone, methyl isoamyl ketone, methyl n-amyl ketone, mesityl oxide, acetophenone, cyclohexanone, diethyl phthalate, ethyl lactate, benzyl acetate, butyrolactone, acetyl acetone, methyl cyclohexanone, benzaldehyde, diisobutyl ketone diacetone alcohol, ethylene glycol, glyceryl-α-monochlorohydrin, propylene glycol, glycol ethers (for example propylene glycol monomethyl ether, ethylene glycol mono-methyl ether, ethylene glycol mono-ethyl ether, ethylene glycol mono-n-butyl ether, propylene glycol mono-tert-butyl ether, propylene glycol monopropyl ether, propylene glycol monobutyl ether), glycol ether esters (for example ethylene glycol mono-methyl ether acetate, ethylene glycol mono-ethyl ether acetate, ethylene glycol mono-butyl ether acetate, ethylene glycol diacetate), n-propyl alcohol, iso-propyl alcohol, n-butanol, sec-butanol, isobutanol, benzyl alcohol, diisopropyl ether, dimethoxymethane, dimethoxyethane, 1,4-dioxane, 1,3-dioxolane, tetrahydrofuran, anisole, phenetole and dimethyl formamide Other examples of solvents include dimethyl sulfoxide, toluene, xylene, n-methyl-2-pyrrolidone, methyl chloride, chloroform, carbon tetrachloride, trichloroacetic acid, methyl bromide, methyl iodide, trichloroethylene, and tetrachloroethylene. The organic solvent can be a mixture of two or more solvents. The organic solvent can comprise water, although typically the water content of the organic solvent(s) is less than 5 wt %, i.e. 0 to 5 wt % water, for example 0 to 1 wt % water.

In embodiments, the solvent is selected from one or more of ethyl acetate, methyl acetate, ethyl formate and acetone. Particularly preferred is that the solvent is acetone.

Typically, the acetate-functionalised cellulose content in the mixture for spray drying is typically in the range of from 0.1 to 50 wt %. In embodiments, it can be in the range of from 1 to 40 wt %, for example in the range of from 2 to 35 wt % or even from 5 to 10 wt %. The wt % are based on the total weight of the mixture for spray drying.

The amount of blowing agent(s) in the mixture for spray drying is typically in the range of from 0.5 to 50 wt %. In embodiments, it can be in the range of from 0.5 to 40 wt %, for example in the range of from 1 to 30 wt % or even from 3 to 25 wt %. In embodiments, the weight of blowing agent in the mixture for spray drying is equal to or less than the weight of acetate-functionalised cellulose, for example the weight ratio of blowing agent to acetate-functionalised cellulose can be 1.5 or less, for example 1.3 or less or even 1.1 or less. In embodiments the minimum weight ratio is 0.1, or in further embodiments 0.2. In embodiments, the weight ratio of blowing agent to acetate-functionalised cellulose in the organic phase is in the range of from 0.1 to 1.5, such as in the range of from 0.2 to 1.3 or even from 0.3 to 1.1.

The amount of hydrogen bond donor chosen from alcohols, urea, and carboxylic acids, preferably the hydrogen bond donor in the form of a carboxylic acid, in the mixture for spray drying is typically in the range of from 0.01 to 15 wt %, for example in the range of from 0.05 to 10 wt %, in the range of from 0.1 to 5 wt % or even in the range of from 0.1 to 3.0 wt %, such as from 0.1 to 1.0 wt %. The wt % are based on the total weight of acetate-functionalised cellulose, blowing agent, hydrogen bond donor chosen from alcohols, urea, and carboxylic acids, preferably the hydrogen bond donor in the form of a carboxylic acid, and solvent in the mixture for spray drying.

For instance, if cellulose acetate propionate (CAP) or cellulose acetate butyrate (CAB) is used as the polymer, the amount of the hydrogen bond donor chosen from alcohols, urea, and carboxylic acids, preferably the hydrogen bond donor in the form of a carboxylic acid, which is used may be from 0.01 to 15 wt %. In embodiments, it can be in the range of from 0.05 to 10 wt %, in the range of from 0.1 to 5 wt % or even in the range of from 0.1 to 3.0 wt %, such as from 0.1 to 1.0 wt %. The wt % are based on the total weight of acetate-functionalised cellulose, blowing agent, hydrogen bond donor chosen from alcohols, urea, and carboxylic acids, preferably the hydrogen bond donor in the form of a carboxylic acid, and solvent in the mixture for spray drying.

For instance, if in a preferred embodiment cellulose acetate (CA) (i.e. acetate-functionalized cellulose which does not comprise a further carboxylate functionality different from acetate) is used as the polymer, the amount of the hydrogen bond donor chosen from alcohols, urea, and carboxylic acids, preferably the hydrogen bond donor in the form of a carboxylic acid, which is used may be in the range of from 0.01 to 15 wt %, for example in the range of from 0.05 to 10 wt %, in the range of from 0.1 to 5 wt % or even in the range of from 0.1 to 1.0 wt %. The wt % are based on the total weight of acetate-functionalised cellulose, blowing agent, hydrogen bond donor chosen from alcohols, urea, and carboxylic acids, preferably the hydrogen bond donor in the form of a carboxylic acid, and solvent in the mixture for spray drying.

The amount of the organic solvent adds up to 100 wt %. Preferably, the amount of organic solvent is at least 30 wt %, more preferably at least 40 wt % and even more preferably at least 50 wt %. The wt % are based on the total weight of the mixture for spray drying.

The amount of the hydrogen bond donor chosen from alcohols, urea, and carboxylic acids, preferably the hydrogen bond donor in the form of a carboxylic acid, in the mixture for spray drying may also be from 0.01 to 50 wt % based on the total weight of the hydrogen bond donor chosen from alcohols, urea, and carboxylic acids, preferably the hydrogen bond donor in the form of a carboxylic acid, and the acetate-functionalised cellulose in the mixture for spray drying. In embodiments, it can be in the range of from 0.1 to 40 wt %, for example in the range of from 0.5 to 35 wt %, in the range of from 1 to 30 wt % or even in the range of from 2 to 25 wt %, the wt % being based on the total weight of the hydrogen bond donor chosen from alcohols, urea, and carboxylic acids, preferably the hydrogen bond donor in the form of a carboxylic acid, and the acetate-functionalised cellulose in the mixture for spray drying.

The unexpanded microspheres typically have volume mean particle sizes (diameters), i.e. D(0.5) values, in the range of from 1 to 500 μm, such as 5 to 200 μm or, in embodiments, from 10 to 100 μm or even from 15 to 80 μm.

The expanded microspheres are typically in the range of from 1.5 to 8 times larger in diameter than unexpanded microspheres, for example 2 to 7 times or 3 to 6 times their original diameter.

The particle sizes are suitably measured using light scattering techniques, e.g. laser diffraction, such as low angle laser light scattering (LALLS). They can also be measured by image analysis from a photograph or electronic micrograph image of the pre- or post-expanded microspheres.

To expand the expandable microspheres, they can be heated to a temperature above the higher of the boiling point of the blowing agent and the T_{g} of the functionalised cellulose, and also a temperature below the melting point of the microspheres. To halt the expansion, the microspheres can be cooled back down to below the T_{g} of the functionalised cellulose and/or the boiling point of the blowing agent.

Ways of heating the expandable microspheres include direct or indirect contact with a heat transfer medium such as steam or pressurised steam, as described for example in WO2004/056549, WO2014/198532 and WO2016/091847. In further embodiments, direct or indirect contact with other heated gases (e.g. air or nitrogen) optionally mixed with steam can be used. In still further embodiments, where indirect heating is used, a liquid heat transfer medium can be used, e.g. heated oil. In another embodiment, IR radiation can be used to heat the microspheres.

Expansion properties of the thermally expandable thermoplastic microspheres can be evaluated using a thermomechanical analyser (e.g. a Mettler TMA 841) and quantitative data can be obtained from images using suitable software, for example STARe software.

The expandable or expanded thermoplastic microspheres may be provided in unexpanded form, e.g. for expansion local to their point of use, or they can be pre-expanded before dispatch to the point of end use.

The microspheres can find use in many applications, for example in the manufacture of paper (e.g. embossed paper, a paper filler, a sizing agent), inks, corks, cement based compositions, adhesives, foams, insulation materials, coatings, rubber-based products, thermoplastics, thermosets, ceramics, non-woven composite materials, fillers etc. to provide for example a lightweight filler in such applications.

The thermally expandable microspheres described herein can be thermally expanded when dry, when wet or when in a slurry. They are also able to withhold the blowing agent for extended periods of time, e.g. at least 1 week, such as at least one month or at least 4 months. In addition, their expansion is typically irreversible, i.e. cooling the microspheres after thermal expansion does not result in their contraction back to their pre-expanded size.

Another second aspect of the present disclosure is a process for preparing thermally expandable microspheres, the process comprising mixing an acetate-functionalised cellulose having a glass transition temperature within the range of from 150 to 250° C., an organic solvent, a blowing agent and a hydrogen bond donor chosen from alcohols, urea, and carboxylic acids, preferably a hydrogen bond donor in the form of a carboxylic acid, and then spraying the thus obtained mixture into a drying equipment to produce the thermally expandable microspheres having a polymeric shell surrounding a hollow core, in which the polymeric shell comprises the acetate-functionalised cellulose, and the hollow core comprises the blowing agent.

The process parameters, the spray drying equipment, the acetate-functionalised cellulose, the organic solvent, the blowing agent, the hydrogen bond donor chosen from alcohols, urea, and carboxylic acids, preferably the hydrogen bond donor in the form of a carboxylic acid, as well as amounts thereof are the same as already described above and equally apply for the process according to the second aspect of the present disclosure.

In even further embodiments the process for preparing thermally expandable microspheres further comprises a step of storing the prepared thermally expandable microspheres after preparation for at least two weeks, and preferably for at least four weeks, before the thermally expandable microspheres are expanded. Surprisingly, it has been found that the storage of the prepared thermally expandable microspheres may improve the expanded density of the thermally expandable microspheres. The expanded density represents the density of the microspheres at maximum expansion of the thermally expandable microspheres. The expanded density can be determined using standard measuring techniques as commonly known by the skilled person. For instance, the expanded density can also be determined in a temperature ramping experiment as described above for the determination of T_{Start}, i.e. by using for example a Mettler-Toledo Thermomechanical Analyser, such as Mettler-Toledo TMA/SDTA 841e, and analysis of the obtained expansion thermogram for instance by using STARe software from Mettler-Toledo. A typical value determined for the density using such equipment is called the TMA-density. The TMA-density is calculated using the equation: weight of the sample [g] divided by the volume increase of the sample [dm³] at maximum expansion. A lower TMA-density usually indicate more desirable expansion properties. A TMA density of 0.2 g/cm³ or lower is considered to be desirable and a TMA density of at least 0.15 g/cm³ or lower is considered to be particularly desirable.

In a further aspect, the present disclosure is also directed to thermally expandable microspheres obtained by the process for preparing thermally expandable microspheres as described above.

### EXAMPLES

The following examples are intended to illustrate the present disclosure.
The expansion characteristics were evaluated using a Mettler TMA/SDTA 841e thermomechanical analyser, interfaced with a PC running STARe software. The sample to be analysed was prepared from 0.5 mg (+/−0.02 mg) of the thermally expandable microspheres contained in an aluminum oxide crucible with a diameter of 6.8 mm and a depth of 4.0 mm The crucible was sealed using an aluminum oxide lid with a diameter of 6.1 mm Using a TMA Expansion Probe type, the temperature of the sample was increased from about 30° C. to 240° C. with a heating rate of 20° C./min while applying a load (net.) of 0.06 N with the probe. The displacement of the probe vertically was measured to analyze the expansion characteristics. Initial temperature of expansion (Tₛₜₐᵣₜ): the temperature (° C.) when displacement of the probe is initiated.
Maximum temperature of expansion (Tₘₐₓ): the temperature (° C.) when displacement of the probe reaches its maximum.
Maximum displacement (Lₘₐₓ): the displacement (μm) of the probe when displacement of the probe reaches its maximum.
TMA density: sample weight (d) divided by volume increase of the sample (dm³) when displacement of the probe reaches its maximum.

The parameters were determined as illustrated by the illustrative example shown in FIG. 2.

The volatile content in the microspheres was determined using a Mettler Toledo TGA/DSC1 TGA-instrument.

Gas chromatography-flame-ionization detection (GC-FID) analyses have been performed using an Agilent 7697A Headspace in combination with an Agilent 7890A GC.

Differential Scanning Calorimetery (DSC) measurements were obtained using a Mettler Toledo DSC 822e device.

### General Synthesis Method:

For the experiments of Examples 1 and 2, all components (solvent, polymer, hydrogen bond donor and blowing agent) were mixed and left to stir overnight with the use of a magnetic stirrer.

The thus obtained mixtures were then spray-dried using a Büchi Mini Spray Dryer B-290. Nitrogen was used as spray gas with a feed rate of 2381/h. The feed rate of the mixture to be spray dried was measured to be about 12-13 ml/min The temperature of the drying gas at the inlet was 105° C. and the aspirator rate was 38 m³/h and the temperature at the outlet was around 78-80° C. and the spraying time was around 4 minutes.

Dried solids were collected from the bottom of the cyclone and analysed within a few days or after storage.

Table 1 lists the acetate-functionalised cellulose polymer (cellulose acetate (CA1)) that was used to prepare microspheres and properties thereof. Table 1 also lists a further suitable acetate-functionalised cellulose polymer, i.e. a cellulose with acetate and butyrate functionalities (CAB1) having a degree of substitution (DS) by acetate in the range of from 2.0 to 3.0 and a degree of substitution (DS) by butyrate of no more than 1.

TABLE 1
Acetate-functionalised cellulose details

| | | | | Acetate | | | Total | Molecular | T_{g}/ | Tₘ/ |
|---|---|---|---|---|---|---|---|---|---|---|
| Polymer | | Hydroxyl | | Content/wt % | | Butyrate | DS | Weight | ° C. | ° C. |
| Reference | Source | Content/wt % | | (DS) | | Content | (1) | (2) | (3) | (4) |
| CA1 | Eastman | 3.5 | (0.55) | 39.8 | (2.45) | — | 3.0 | 30 000 | 180 | 230-250 |
| CAB1 | Eastman | 1.1 | (0.19) | 29 | (2.03) | 18 (0.76) | 2.98 | 65 000 | 161 | 230-240 |

(1) DS = Degree of substitution. Total DS = sum of DS of individual substituents
(2) Number Average Molecular Weight (in Da), as provided by supplier
(3) Glass transition temperature as provided by supplier (Eastman)
(4) Melting Point, as provided by supplier
— Not applicable

### Example 1

The influence of various dosages of different hydrogen bond donors on Tₛₜₐᵣₜ, Tₘₐₓ and the TMA density was examined using CA1 as the polymer for the polymer shell.

The mixtures of all experiments of Example 1 contained 2.25 g CAL 26.5 g acetone and 1.2 g isooctane. Various hydrogen bond donors were added in various dosages from 1 to 10 wt % (based on the total weight of hydrogen bond donor and CA1) as indicated in Table 2. (PMA=Pyromellitic acid; BTCA=1,2,3,4-butanetetracarboxylic acid; PAA (2000)=polyacrylic acid with a weight average molecular weight of 2000 g/mol)

TABLE 2
Microsphere properties

| | | | Encapsulated | | | |
|---|---|---|---|---|---|---|
| | | Dosage | amount of | | | TMA- |
| | Hydrogen | [wt %] | isooctane | | | density/g |
| Experiment | bond donor | (1) | (wt %) (2) | Tₛₜₐᵣₜ/° C. | Tₘₐₓ/° C. | dm⁻³ |
| 1 | — | — | 10.5 ‡ | 180 | 221 | 19 |
| 2 | PMA | 1 | 15.8 | 175 | 217 | 21 |
| 3 | PMA | 3 | 17.9 | 170 | 210 | 43 |
| 4 | PMA | 5 | 18.3 | 167 | 210 | 45 |
| 5 | Citric acid | 1 | 14.7 | 172 | 217 | 23 |
| 6 | Citric acid | 3 | 17.5 | 167 | 211 | 39 |
| 7 | Citric acid | 5 | 19.7 | 168 | 206 | 33 |
| 8 | Tartaric | 1 | 16.1 | 167 | 218 | 23 |
| | acid | | | | | |
| 9 | Tartaric | 3 | 17.9 | 167 | 216 | 35 |
| | acid | | | | | |
| 10 | Tartaric | 5 | 18.9 | 167 | 213 | 39 |
| | acid | | | | | |
| 11 | BTCA | 1 | 16.1 | 173 | 217 | 19 |
| 12 | BTCA | 3 | 17.3 | 172 | 213 | 21 |
| 13 | BTCA | 5 | 18.1 | 171 | 209 | 27 |
| 14 | Succinic | 3 | 18.2 | 170 | 218 | 21 |
| | acid | | | | | |
| 15 | Succinic | 5 | 20.4 | 167 | 216 | 22 |
| | acid | | | | | |
| 16 | Succinic | 10 | 22.5 | 158 | 213 | 30 |
| | acid | | | | | |
| 17 | Lactic acid | 3 | 16.8 | 170 | 219 | 20 |
| 18 | Lactic acid | 5 | 17.9 | 171 | 218 | 21 |
| 19 | Lactic acid | 10 | 19.1 | 169 | 218 | 28 |
| 20 | Benzoic | 3 | 15.9 | 170 | 219 | 20 |
| | acid | | | | | |
| 21 | Benzoic | 5 | 16.7 | 170 | 221 | 20 |
| | acid | | | | | |
| 22 | PAA | 3 | 17.4 | 174 | 225 | 23 |
| | (2000) | | | | | |
| 23 | PAA | 5 | 18.6 | 174 | 220 | 21 |
| | (2000) | | | | | |
| 24 | PAA | 10 | 20.9 | 172 | 221 | 36 |
| | (2000) | | | | | |
| 25 | Urea | 3 | 21.5 | 168 | 218 | 24 |
| 26 | Urea | 5 | 23.6 | 164 | 216 | 33 |
| 27 | Urea | 10 | 26.3 | 163 | 214 | 57 |
| 28 | Sorbitol (D) | 3 | 15.3 | 172 | 212 | 20 |
| 29 | Sorbitol (D) | 5 | 15.8 | 172 | 216 | 21 |
| 30 | Vitamin C | 3 | 17.8 | 169 | 211 | 30 |
| | (ascorbic | | | | | |
| | acid) | | | | | |
| 31 | Glycerol | 3 | 18.2 | 172 | 218 | 18 |
| 32 | Glycerol | 5 | 19.8 | 169 | 218 | 21 |
| 33 | Glycerol | 10 | 21.9 | 168 | 222 | 27 |
| 34 | 1,3- | 3 | 16.6 | 175 | 222 | 17 |
| | Butanediol | | | | | |
| 35 | 1,3- | 5 | 17.8 | 175 | 220 | 20 |
| | Butanediol | | | | | |
| 36 | 1,3- | 10 | 17.4 | 174 | 219 | 19 |
| | Butanediol | | | | | |

(1) Based on the total weight of hydrogen bond donor and CA1
(2) Volatile content of the microspheres, measured by TGA; based on the total weight of the microspheres
‡ Measured by GC-FID (gas chromatography - flame-ionization detection)

The data obtained in Example 1 reveal that the acetate-functionalised cellulose compositions can be used to make bio-based microspheres having a desirably low TMA-density and having a temperature at which expansion starts, Tₛₜₐᵣₜ, within the range of from 158° C. to 175° C. The results show that the temperature at which expansion starts, Tₛₜₐᵣₜ, is lowered for cellulose acetate having a glass transition temperature of 180° C. by adding a hydrogen bond donor and the data presented in Table 3 of Example 2 below demonstrates that the expansion properties do not significantly change after 4 week of storage of the microspheres. This shows the desirable storage stability of the microspheres of the present disclosure

### Example 2

Storage tests were performed in order to assess the storage stability of the microspheres of the present disclosure after storage for 4 weeks. Table 3 shows the properties Tₛₜₐᵣₜ, Tₘₐₓ and the TMA-density of the microspheres from the experiments of above Example 1 after storage for 4 weeks. For instance, the data provided above in Table 2 for Experiment 2 from Example 1 is for newly made microspheres and the data provided below in Table 3 for corresponding experiment 2 (4 w) is for the very same microspheres with the only difference that it has been measured after 4 week of storage of the microspheres. The results are summarized in Table 3.

TABLE 3
Microsphere properties of the microspheres of Example 1 after 4 weeks storage

| | | | Encapsulated | | | | Percentual |
|---|---|---|---|---|---|---|---|
| | | | amount of | | | | change of |
| | Hydrogen | Dosage | isooctane | | | TMA- | TMA- |
| | bond | [wt %] | [wt %] | Tₛₜₐᵣₜ/ | Tₘₐₓ/ | density/ | density/% |
| Experiment | donor | (1) | (2) | ° C. | ° C. | g dm⁻³ | (3) |
| 1 (4 w) | — | — | 8.1 ‡ | 188 | 221 | 36 | 89 |
| 2 (4 w) | PMA | 1 | 13.7 | 174 | 217 | 19 | −10 |
| 3 (4 w) | PMA | 3 | 17.1 | 173 | 211 | 31 | −28 |
| 4 (4 w) | PMA | 5 | 18.0 | 170 | 205 | 31 | −31 |
| 5 (4 w) | Citric acid | 1 | 12.2 | 174 | 219 | 19 | −17 |
| 6 (4 w) | Citric acid | 3 | 16.2 | 169 | 211 | 25 | −36 |
| 7 (4 w) | Citric acid | 5 | 19.5 | 168 | 206 | 32 | −3 |
| 8 (4 w) | Tartaric | 1 | 13.9 | 173 | 219 | 23 | 0 |
| | acid | | | | | | |
| 9 (4 w) | Tartaric | 3 | 17.1 | 169 | 215 | 24 | −31 |
| | acid | | | | | | |
| 10 (4 w) | Tartaric | 5 | 18.0 | 166 | 214 | 34 | −13 |
| | acid | | | | | | |
| 11 (4 w) | BTCA | 1 | 13.2 | 174 | 218 | 18 | −5 |
| 12 (4 w) | BTCA | 3 | 17.2 | 171 | 214 | 19 | −10 |
| 13 (4 w) | BTCA | 5 | 15.9 | 170 | 210 | 22 | −19 |
| 14 (4 w) | Succinic | 3 | 16.1 | 171 | 218 | 17 | −19 |
| | acid | | | | | | |
| 15 (4 w) | Succinic | 5 | 18.5 | 170 | 218 | 19 | −14 |
| | acid | | | | | | |
| 16 (4 w) | Succinic | 10 | 20.3 | 164 | 213 | 24 | −20 |
| | acid | | | | | | |
| 17 (4 w) | Lactic | 3 | 15.2 | 172 | 223 | 19 | −5 |
| | acid | | | | | | |
| 18 (4 w) | Lactic | 5 | 15.6 | 171 | 219 | 17 | −19 |
| | acid | | | | | | |
| 19 (4 w) | Lactic | 10 | 16.6 | 172 | 219 | 22 | −21 |
| | acid | | | | | | |
| 20 (4 w) | Benzoic | 3 | 13.1 | 172 | 222 | 19 | −5 |
| | acid | | | | | | |
| 21 (4 w) | Benzoic | 5 | 12.6 | 172 | 220 | 18 | −10 |
| | acid | | | | | | |
| 22 (4 w) | PAA | 3 | 16.2 | 175 | 220 | 16 | −30 |
| | (2000) | | | | | | |
| 23 (4 w) | PAA | 5 | 17.7 | 175 | 221 | 19 | −10 |
| | (2000) | | | | | | |
| 24 (4 w) | PAA | 10 | 20.4 | 171 | 221 | 32 | −11 |
| | (2000) | | | | | | |
| 25 (4 w) | Urea | 3 | 20.4 | 168 | 221 | 19 | −21 |
| 26 (4 w) | Urea | 5 | 21.9 | 165 | 217 | 25 | −24 |
| 27 (4 w) | Urea | 10 | 23.6 | 156 | 218 | 41 | −28 |
| 28 (4 w) | Sorbitol | 3 | 13.0 | 171 | 215 | 19 | −5 |
| | (D) | | | | | | |
| 29 (4 w) | Sorbitol | 5 | 13.5 | 172 | 215 | 17 | −19 |
| | (D) | | | | | | |
| 30 (4 w) | Vitamin C | 3 | 17.0 | 170 | 216 | 24 | −20 |
| | (ascorbic | | | | | | |
| | acid) | | | | | | |
| 31 (4 w) | Glycerol | 3 | 16.1 | 173 | 222 | 15 | −17 |
| 32 (4 w) | Glycerol | 5 | 17.8 | 171 | 219 | 15 | −29 |
| 33 (4 w) | Glycerol | 10 | 17.6 | 171 | 223 | 21 | −22 |
| 34 (4 w) | 1,3- | 3 | 14.6 | 174 | 222 | 15 | −12 |
| | Butanediol | | | | | | |
| 35 (4 w) | 1,3- | 5 | 15.8 | 175 | 219 | 14 | −30 |
| | Butanediol | | | | | | |
| 36 (4 w) | 1,3- | 10 | 14.6 | 174 | 220 | 18 | −5 |
| | Butanediol | | | | | | |

(1) Based on the total weight of hydrogen bond donor and CA1
(2) Volatile content of the microspheres, measured by TGA; based on the total weight of the microspheres
(3) Percentual change of TMA density of microspheres after four weeks storage compared to TMA-density of the same microspheres directly after production. Negative values indicate that TMA-density of the microspheres is lower after four weeks storage than directly after production,
‡ Measured by GC-FID (gas chromatography - flame-ionization detection)

The data reveal that although the microspheres slightly loose blowing agent over storage for 4 weeks, the expansion properties Tₛₜₐᵣₜ, Tₘₐₓ and the TMA-density surprisingly do not significantly change and in most cases even improve. This shows the desirable storage stability of the microspheres of the present disclosure.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. Thermally expandable microspheres comprising a polymeric shell surrounding a hollow core, wherein the hollow core comprises a blowing agent, and the polymeric shell comprises an acetate-functionalized cellulose having a glass transition temperature of from about 150 to about 250° C. and a hydrogen bond donor chosen from alcohols, urea, carboxylic acids, and combinations thereof.

2. The thermally expandable microspheres according to claim 1, wherein the hydrogen bond donor is chosen from pyromellitic acid (1,2,4,5-benzenetetracarboxylic acid), citric acid, tartaric acid, butanetetracarboxylic acid, succinic acid, lactic acid, maleic acid, and combinations thereof.

3. The thermally expandable microspheres according to claim 1, wherein the hydrogen bond donor is chosen from citric acid, pyromellitic acid (1,2,4,5-benzenetetracarboxylic acid), and 1,2,3,4-butanetetracarboxylic acid (BTCA), and combinations thereof.

4. The thermally expandable microspheres according to claim 1, wherein the hydrogen bond donor is chosen from 1,3-butanediol, glycerol, pentaerythritol, sorbitol, ascorbic acid and combinations thereof.

5. The thermally expandable microspheres according to claim 1, wherein T_{Start} is from about 150° C. to about 250° C.

6. The thermally expandable microspheres according to claim 1, wherein the amount of the hydrogen bond donor is from about 0.01 to about 50 wt %, the wt % being based on the total weight of the hydrogen bond donor and the acetate-functionalised cellulose.

7. The thermally expandable microspheres according to claim 1, wherein the acetate-functionalised cellulose comprises one or more further carboxylate functionalities different from acetate that are chosen from optionally substituted C₁-C₈ aliphatic carboxylate groups and carboxylate groups comprising an optionally substituted C₆ aromatic ring, wherein the degree of substitution on the acetate-functionalized cellulose is not more than 1.0.

8. The thermally expandable microspheres according to claim 7, wherein the one or more further carboxylate functionalities are chosen from propionate, butyrate, pentanoate, hexanoate, heptanoate, octanoate and phthalate.

9. The thermally expandable microspheres according to claim 1, wherein the acetate-functionalised cellulose does not comprise a further carboxylate functionality different from acetate.

10. The thermally expandable microspheres according to claim 1, wherein the polymeric shell comprises an acetate-functionalised cellulose having a glass transition temperature of from about 150° C. to about 190° C.

11. The thermally expandable microspheres according to claim 1, wherein the acetate-functionalised cellulose has a number average molecular weight (Mₙ) of from about 2,000 to about 100,000 Da.

12. The thermally expandable microspheres according to claim 1, which are obtained by a spray drying process comprising the step of mixing the acetate-functionalised cellulose, an organic solvent, the blowing agent and the hydrogen bond donor to form a mixture and subsequently spraying the mixture into drying equipment to produce the thermally expandable microspheres.

13. A process for preparing thermally expandable microspheres, the process comprising the step of mixing an acetate-functionalised cellulose having a glass transition temperature of from about 150 to about 250° C., an organic solvent, a blowing agent and a hydrogen bond donor chosen from alcohols, urea, and carboxylic acids to form a mixture, and subsequently spraying the mixture into a drying equipment to produce the thermally expandable micro spheres having a polymeric shell surrounding a hollow core, in which the polymeric shell comprises the acetate-functionalised cellulose, and the hollow core comprises the blowing agent.

14. The process according to claim 13, wherein the hydrogen bond donor is added in an amount of from about 0.01 to about 15 wt %, the wt % being based on the total weight of acetate-functionalised cellulose, blowing agent, hydrogen bond donor, and solvent in the mixture for spray drying.

15. The process according to claim 13 further comprising the step of storing the prepared thermally expandable microspheres after preparation for at least two weeks before the thermally expandable microspheres are expanded.
